(19) United States
(12) Patent Application Publication
(10) Pub. No.: US 2013/0169906 A1
(43) Pub. Date: Jul. 4, 2013

(54) LIQUID CRYSTAL DISPLAY DEVICE

(71) Applicants: Youhei Nakanishi, Osaka-shi (JP); Masanobu Mizusaki, Osaka-shi (JP); Takeshi Noma, Osaka-shi (JP); Yuichiro Yamada, Osaka-shi (JP)

(72) Inventors: Youhei Nakanishi, Osaka-shi (JP); Masanobu Mizusaki, Osaka-shi (JP); Takeshi Noma, Osaka-shi (JP); Yuichiro Yamada, Osaka-shi (JP)

(73) Assignee: Sharp Kabushiki Kaisha, Osaka-shi, Osaka (JP)

(21) Appl. No.: 13/821,322

(22) PCT Filed: Sep. 2, 2011
(86) PCT No.: PCT/JP2011/070009

§ 371 Date: Mar. 7, 2013

(30) Foreign Application Priority Data
Sep. 8, 2010 (JP) 2010-201210

(51) Int. Cl. G02F 1/1335

(52) U.S. Cl. CPC G02F 1/133603
USPC 349/69

(57) ABSTRACT

The present invention provides a liquid crystal display device including a polymer layer which is placed on an alignment layer and which controls the alignment of liquid crystal molecules adjacent thereto. The polymer layer is one formed by polymerizing a monomer added to the liquid crystal layer. The monomer is a compound represented by the following formula:

P¹-A¹-(Z¹-A²)ₙ-P² (I)

where P¹ and P² are identical to or different from each other and represent an acrylate group or a methacrylate group; Z¹ represents one or more groups which are identical to or different from each other and which are COO, OCO, or O or indicates that A¹ and A² or A² and A² are directly bonded to each other; a hydrogen atom may be substituted by a hydrogen atom, a methyl group, an ethyl group, or a propyl group; A¹ and A² represent specific phenanthrene groups which are identical to or different from each other. A backlight includes a light source including at least one light-emitting diode. The light-emitting diode emits light with a wavelength of substantially 400 nm or more only.

### TECHNICAL FIELD

The present invention relates to liquid crystal display devices. The present invention particularly relates to a liquid crystal display device in which a polymer layer is placed on an alignment layer for the purpose of enhancing the anchoring force of liquid crystals.

### BACKGROUND ART

Liquid crystal display devices have a small thickness, low weight, and low power consumption and therefore are widely used as display devices for televisions, personal computers, and PDAs. In particular, in recent years, the liquid crystal display devices have been increasingly upsized as typified by liquid crystal display devices for televisions. A multi-domain vertical alignment (MVA) mode which enables high-yield production in spite of large areas and which provides a wide viewing angle is preferably used for upsizing. The MVA mode can provide higher contrast ratio as compared to a conventional TN (twisted nematic) mode because liquid crystal molecules are aligned perpendicularly to a surface of a substrate when no voltage is applied to a liquid crystal layer.

However, the MVA mode uses ribs (protrusions), which cause a reduction in aperture ratio, and therefore has a drawback, that is, low white level. In order to improve the drawback, the distance between the ribs may be increased. This leads to a reduction in the number of the ribs, which are anchoring structures, and therefore causes a problem that the response speed is low because it takes time to stabilize the alignment of liquid crystals after a predetermined voltage is applied to the liquid crystals. In order to improve the problem and in order to enable high luminance and high-speed response, a pretilt angle control technique (hereinafter also referred to as “PSA (polymer sustained alignment) layer”) using a polymer has been proposed (refer to, for example, Patent Literatures 1 to 5). In the PSA technique, a liquid crystal composition prepared by mixing a liquid crystal with a polymerizable component (hereinafter simply referred to as “monomer or the like”) such as a monomer, an oligomer, or the like is sealed between substrates and the monomer or the like is polymerized in such a state that molecules of the liquid crystal are tilted by applying a voltage between the substrates. This allows the liquid crystal to have a predetermined pretilt angle even after the applied voltage is removed, that is, the orientation of the liquid crystal can be controlled. The monomer or the like is polymerized by heating or light (ultraviolet ray) irradiation. The use of the PSA technique eliminates the need for the ribs to increase the aperture ratio, allows the whole of a display region to have a pretilt angle of less than 90 degrees, and enables high-speed response.

### CITATION LIST

### Patent Literatures

PTL 1: Japanese Unexamined Patent Application Publication No. 2003-307720
PTL 2: Japanese Unexamined Patent Application Publication No. 2009-132718
PTL 3: WO 2009/118086
PTL 4: Chinese Patent No. 101008784
PTL 5: U.S. Patent Application Publication No. 2008/179565

### SUMMARY OF INVENTION

### Technical Problem

However, investigations made by the inventors have shown that even though a polymer layer for increasing the anchoring force is formed on an alignment layer in such a manner that a liquid crystal composition containing a liquid crystal material, a monomer, a polymerization initiator, and the like is sealed between a pair of substrates and a polymerization reaction is then carried out under predetermined conditions, a conventional PSA technique causes “image sticking”, in which a displayed image remains slightly visible after the same pattern is displayed for a long time and is then switched to another pattern. A cause of image sticking is that a direct-current offset voltage is generated in cells because of the presence of charged substances (ions, radical generators, or the like) and therefore a liquid crystal is not desirably oriented when a voltage is applied to a liquid crystal layer.

The inventors have investigated various methods capable of preventing image sticking and have focused on a polymer layer (PSA layer) which is placed on an alignment layer for the purpose of increasing the anchoring force.

FIG. 8 is a graph illustrating an example of the absorbance (a. u.) of monomers. As shown in FIG. 8, a biphenyl-based monomer represented by Chemical Formula (2) below is one generating radicals when being irradiated with light with a wavelength of 320 nm or less.

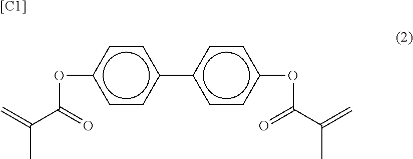

However, in general, a substrate, having an alignment layer on a surface thereof, for use in liquid crystal display devices is unlikely to transmit light with a wavelength of less than 330 nm under the influence of a main chain and side chain of a polymer making up the alignment layer. On the other hand, most of high-pressure mercury lumps used as common light sources emit light that has a small emission line peak centered at 313 nm and high emission intensity at 330 nm or more. Therefore, in order to sufficiently photo-polymerize a referential monomer, 313-nm ultraviolet light needs to be applied to the monomer for a long time or several times. However, applying such ultraviolet light for a long time or several times deteriorates members (for example, an alignment layer and a liquid crystal layer) of a liquid crystal display device to failures such as image sticking in some cases. On the other hand, in the case of applying ultraviolet light for a short time for the purpose of preventing the deterioration of an alignment layer and a liquid crystal layer, a monomer is not sufficiently polymerized, an incomplete PSA layer is formed, and failures such as image sticking are caused in some cases. The inventors have noted that the light use efficiency can be increased by the use of, for example, a phenanthrene-based monomer, represented by Chemical Formula (3) below, absorbing light with a wavelength of 330 nm or more and have found that a stable PSA layer can be formed even by short-term, single-dose irradiation.

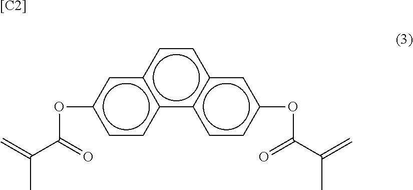

As a result, the inventors have found that a residual DC voltage can be prevented from being caused in a liquid crystal layer and image sticking can be reduced.

The inventors have made further investigations to clarify that a new problem below occurs even if the phenanthrene-based monomer is used. The problem is that after a series of polymerization reactions are completed in such a manner that a liquid crystal composition containing a liquid crystal material, the monomer, a polymerization initiator, and the like is injected between a pair of substrates and is then irradiated with light, the unreacted monomer and polymerization initiator remain in a liquid crystal layer. When the unreacted monomer and polymerization initiator remain in the liquid crystal layer, the unreacted monomer begins to polymerize slowly under the influence of light from a backlight used in an ordinary way after completion or the influence of an ageing step, subsequent to an assembling step, for inspection, resulting in that a PSA layer formed so as to follow aligned liquid crystal molecules is varied in shape and failures such as image sticking are caused.

That is, it has become clear that the phenanthrene-based monomer has advantages such as a wider absorption wavelength range and higher reaction rate as compared to biphenyl-based monomers and, however, contains a factor increasing the probability of causing image sticking because the phenanthrene-based monomer exhibits reactivity with light from a backlight used in an ordinary way to newly form a polymer layer.

The present invention has been made in view of the foregoing circumstances. It is an object of the present invention to provide a liquid crystal display device in which image sticking due to a monomer remaining in a liquid crystal layer is unlikely to occur.

### Solution to Problem

The inventors have investigated various methods of preventing image sticking to focus on the type of a light source for use in backlights. The inventors have found that in the case of using a common cold cathode fluorescent lamp (CCFL) as a light source for use in backlights, light emitted from the CCFL contains ultraviolet rays and therefore causes a phenanthrene-based monomer having an absorption wavelength in an ultraviolet range to be polymerized. The inventors have also found that the polymerization of a monomer due to light from a backlight can be suppressed in such a way that a light-emitting diode (LED) is used as a light source of the backlight and is designed such that light emitted from the LED contains no ultraviolet rays.

FIG. 9 is a graph showing an example of the emission spectrum of each of a CCFL and an LED. FIG. 10 is an enlarged graph showing the emission spectrum of the CCFL shown in FIG. 9 in the range of 350 nm to 420 nm. The CCFL excites mercury to emit light and therefore, in principle, has small peaks centered at about 313 nm, about 365 nm, and about 405 nm, that is, in the ultraviolet region. The CCFL further has large peaks centered at about 440 nm, about 490 nm, about 550 nm, about 590 nm, and about 610 nm. On the other hand, the LED has a large peak centered at about 450 nm and a broad peak centered at about 570 nm. The LED has no peak in the ultraviolet region.

Light is attenuated by the influence of a member, such as sheet, placed on the front side of a light source. However, for example, a TAC (triacetyl cellulose) film has a transmittance of 0.1% at 365 nm and a transmittance of 80% or more at 405 nm. Therefore, it is substantially difficult to prevent image sticking only using a member, such as a sheet, located in front of a light source. On the other hand, the LED spreads a single spectrum into a predetermined spectrum using a phosphor. Therefore, the LED, in principle, has no emission spectrum in the ultraviolet region; hence, unnecessary wavelengths can be cut.

On the other hand, the inventors have investigated various techniques for preventing a liquid crystal layer of a completed liquid crystal display device from being irradiated with ultraviolet rays contained in light from a backlight to focus on a method of preventing ultraviolet rays using a color filter generally used in liquid crystal display devices. In particular, an image sticking test was performed in such a manner that a color filter is attached to a substrate located closer to a backlight than a liquid crystal layer, whereby it has been found that image sticking can be suppressed.

FIG. 11 is a graph showing an example of the transmission spectrum of a color filter composed of red, green, and blue. As shown in FIG. 11, the color filter provides a graph in which the transmittance thereof gradually increases from a wavelength of about 350 nm to reach about 500 nm, decreases to about 580 nm once, increases to about 600 nm again, and goes flat to 780 nm.

As described above, the color filter exhibits the ability to absorb ultraviolet light with a wavelength of 350 nm or less. In this case, the polymerization rate of a remaining monomer decreases.

The inventors have appreciated that the above problems can be well solved and have reached the present invention.

That is, an aspect of the present invention provides a liquid crystal display device (hereinafter also referred to as the first liquid crystal display device according to the present invention) including a liquid crystal display panel including a pair of substrates and a liquid crystal layer interposed between the substrates and a backlight placed in rear of the liquid crystal display panel. At least one of the substrates includes an alignment layer controlling the alignment of liquid crystal molecules adjacent thereto and a polymer layer which is placed on the alignment layer and which controls the alignment of the liquid crystal molecules adjacent thereto. The polymer layer is one formed by polymerizing a monomer added to the liquid crystal layer. The monomer is a compound represented by the following formula:

P¹-A¹-(Z¹-A²)ₙ-P² (I)

where P¹ and P² are identical to or different from each other and represent an acrylate group or a methacrylate group; Z¹ represents one or more groups which are identical to or different from each other and which are COO, OCO, or O or indicates that A¹ and A² or A² and A² are directly bonded to each other; a hydrogen atom may be substituted by a hydrogen atom, a methyl group, an ethyl group, or a propyl group; A¹ and A² represent groups which are identical to or different from each other and each of which is represented by a corresponding one of Chemical Formulae (1-1) to (1-4) below.

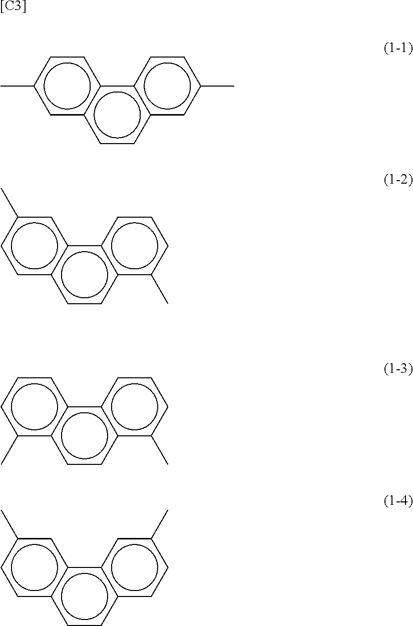

(A hydrogen atom may be substituted by a fluorine atom, a chlorine atom, an OCF₃ group, a CF₃ group, a CH₃ group, a CH₂F group, or a CHF₂ group.) The backlight includes a light source including at least one light-emitting diode. The light-emitting diode emits light with a wavelength of substantially 400 nm or more only.

Another aspect of the present invention provides a liquid crystal display device (hereinafter also referred to as the second liquid crystal display device according to the present invention) including a liquid crystal display panel including a pair of substrates and a liquid crystal layer interposed between the substrates and a backlight placed in rear of the liquid crystal display panel. At least one of the substrates includes an alignment layer controlling the alignment of liquid crystal molecules adjacent thereto and a polymer layer which is placed on the alignment layer and which controls the alignment of the liquid crystal molecules adjacent thereto. The polymer layer is one formed by polymerizing a monomer added to the liquid crystal layer. The monomer is a compound represented by the following formula:

P¹-A¹-(Z¹-A²)ₙ-P² (I)

where P¹ and P² are identical to or different from each other and represent an acrylate group or a methacrylate group; Z¹ represents one or more groups which are identical to or different from each other and which are COO, OCO, or O or indicates that A¹ and A² or A² and A² are directly bonded to each other; a hydrogen atom may be substituted by a hydrogen atom, a methyl group, an ethyl group, or a propyl group; A¹ and A² represent groups which are identical to or different from each other and each of which is represented by a corresponding one of Chemical Formulae (1-1) to (1-4) below.

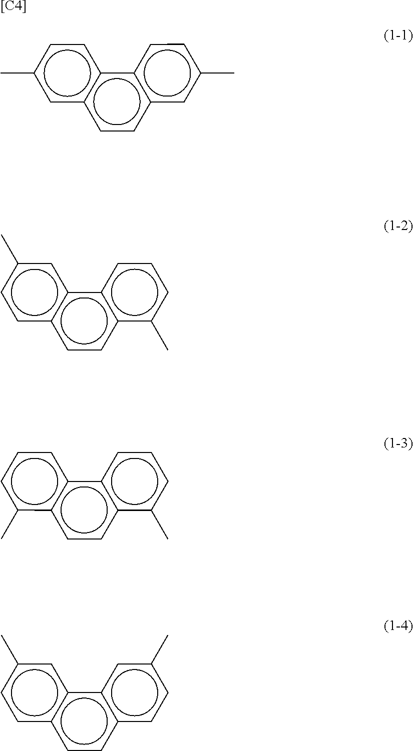

(A hydrogen atom may be substituted by a fluorine atom, a chlorine atom, an OCF₃ group, a CF₃ group, a CH₃ group, a CH₂F group, or a CHF₂ group.) One of the substrates that is closer to the backlight includes a multi-color filter. The multi-color filter transmits light with a wavelength of substantially 350 nm or more only.

The first and second liquid crystal display devices according to the present invention are described below in detail.

The term “front” as used herein refers to a direction in which an observer is located when the observer views a liquid crystal display screen used in an ordinary way. The term “rear” as used herein refers to a direction in which a liquid crystal display device is located when an observer views a liquid crystal display screen used in an ordinary way.

At least one of a pair of the substrates, which are included in each of the first and second liquid crystal display devices according to the present invention, includes the alignment layer, which controls the alignment of the liquid crystal molecules adjacent thereto. In the present invention, the alignment layer may be either one not subjected to alignment treatment or one subjected to alignment treatment. In the case of carrying out alignment treatment, examples of alignment treatment include rubbing and photo-alignment treatment.

At least one of a pair of the substrates, which are included in each of the first and second liquid crystal display devices according to the present invention, is placed on the alignment layer and includes the polymer layer, which controls the alignment of the liquid crystal molecules adjacent thereto. The polymer layer is one formed by polymerizing the monomer, which is contained in the liquid crystal layer. The formation of the polymer layer allows the initial tilt of the liquid crystal molecules adjacent to the alignment layer and the polymer layer to be adjusted to a certain direction. For example, in the case where the polymer layer is formed in such a manner that the monomer is polymerized in such a state that the liquid crystal molecules are pre-tilted, the polymer layer is formed so as to have a structure pre-tilting the liquid crystal molecules.

The monomer is the compound represented by General Formula (I). The condensed aromatic structures represented by Chemical Formulae (1-1) to (1-4) have the ability to absorb light with a wavelength of up to about 370 nm. Therefore, the light use efficiency can be increased, a PSA layer is sufficiently formed even by short-term, single-dose irradiation, and a DC voltage can be prevented from remaining in the liquid crystal layer. Since only short-term photoirradiation is required, members can be can be prevented from being deteriorated due to long-term photoirradiation and therefore the reliably of a liquid crystal display device can be improved.

In the first liquid crystal display device according to the present invention, the light source of the backlight includes at least one light-emitting diode and the light-emitting diode emits light with a wavelength of substantially 400 nm or more only. That is, in the first liquid crystal display device, the LED is used instead of a CCFL used as a backlight source and is selected so as not to substantially emit ultraviolet light with a wavelength of less than 400 nm. The use of such a light source prevents the polymerization of the monomer from proceeding in the general usage pattern of the completed liquid crystal display device and therefore the occurrence of image sticking can be suppressed. From the viewpoint of reliably achieving advantageous effects of the present invention, the light-emitting diode preferably emits light with a wavelength of 420 nm or more only. The wavelength range of light emitted from the light-emitting diode can be varied depending on the type or thickness of a phosphor. A light source emitting light with a wavelength of 405 nm is obtained using, for example, an InGaAs light-emitting diode. In principle, light converted by the phosphor has a wavelength greater than that of light emitted therefrom.

In the second liquid crystal display device according to the present invention, one of the substrates that is closer to the backlight includes a multi-color filter and the multi-color filter transmits light with a wavelength of substantially 350 nm or more only. The multi-color filter preferably transmits light with a wavelength of substantially 420 nm or more only. The term “color filter” as used herein refers to a filter capable of transmitting a specific wavelength component. For example, a “red color filter” transmits a wavelength component with a dominant wavelength of 605 nm to 700 nm, a “green color filter” transmits a wavelength component with a dominant wavelength of 500 nm to 560 nm, and a “blue color filter” transmits a wavelength component with a dominant wavelength of 435 nm to 480 nm. Each of the color filters transmits the wavelength component of a corresponding one of colors and reflects or absorbs other wavelength components. Therefore, the placement of each color filter between the liquid crystal layer and the backlight can effectively prevent the liquid crystal layer from being irradiated with ultraviolet light. The use of the color filter as described above prevents the polymerization of the monomer from proceeding in the general usage pattern of the completed liquid crystal display device and therefore the occurrence of image sticking can be suppressed.

The configuration of a liquid crystal display device according to the present invention is not particularly limited by other elements as long as the liquid crystal display device is composed of such essential elements.

In a liquid crystal display device according to a preferred embodiment of the present invention, features of the first and second liquid crystal display devices according to the present invention are used in combination. That is, in the first liquid crystal display device according to the present invention, one of the substrates that is closer to the backlight includes a multi-color filter and the multi-color filter preferably transmits light with a wavelength of substantially 350 nm or more only and more preferably substantially 420 nm or more. In the second first liquid crystal display device according to the present invention, a light source of the backlight includes at least one light-emitting diode and the light-emitting diode preferably emits light with a wavelength of substantially 400 nm or more only and more preferably substantially 420 nm or more.

### Advantageous Effects of Invention

In a liquid crystal display device according to the present invention, a liquid crystal layer of the completed liquid crystal display device can be prevented from being irradiated with ultraviolet light; hence, advantages due to the use of a phenanthrene-based monomer can be secured and the occurrence of image sticking due to a remaining monomer can be suppressed.

### BRIEF DESCRIPTION OF DRAWINGS

FIG. 1 is a schematic sectional view of a liquid crystal display device according to a first embodiment and shows the liquid crystal display device before a PSA polymerization step.

FIG. 2 is a schematic sectional view of the liquid crystal display device according to the first embodiment and shows the liquid crystal display device after the PSA polymerization step.

FIG. 3 is a schematic plan view of a substrate included in the liquid crystal display device according to the first embodiment and shows an array substrate.

FIG. 4 is a schematic plan view of a substrate included in the liquid crystal display device according to the first embodiment and shows a counter substrate.

FIG. 5 is a schematic plan view of a modification of pixel electrodes of the liquid crystal display device according to the first embodiment.

FIG. 6 is a schematic sectional view of a liquid crystal display device according to a second embodiment and shows the liquid crystal display device before a PSA polymerization step.

FIG. 7 is a schematic sectional view of the liquid crystal display device according to the second embodiment and shows the liquid crystal display device after the PSA polymerization step.

FIG. 8 is a graph illustrating an example of the absorbance (a. u.) of monomers.

FIG. 9 is a graph showing an example of the emission spectrum of each of a CCFL and an LED.

FIG. 10 is an enlarged graph showing the emission spectrum of the CCFL shown in FIG. 9 in the range of 350 nm to 420 nm.

FIG. 11 is a graph showing an example of the transmission spectrum of a color filter composed of red, green, and blue.

FIG. 12 is a graph showing an example of the emission spectrum of a white LED.

FIG. 13 is a graph showing an example of the transmission spectrum of a color filter composed of red, green, and blue.

### DESCRIPTION OF EMBODIMENTS

Embodiments are presented below and the present invention is described in detail with reference to the attached drawings. The present invention is not limited to the embodiments.

### First Embodiment

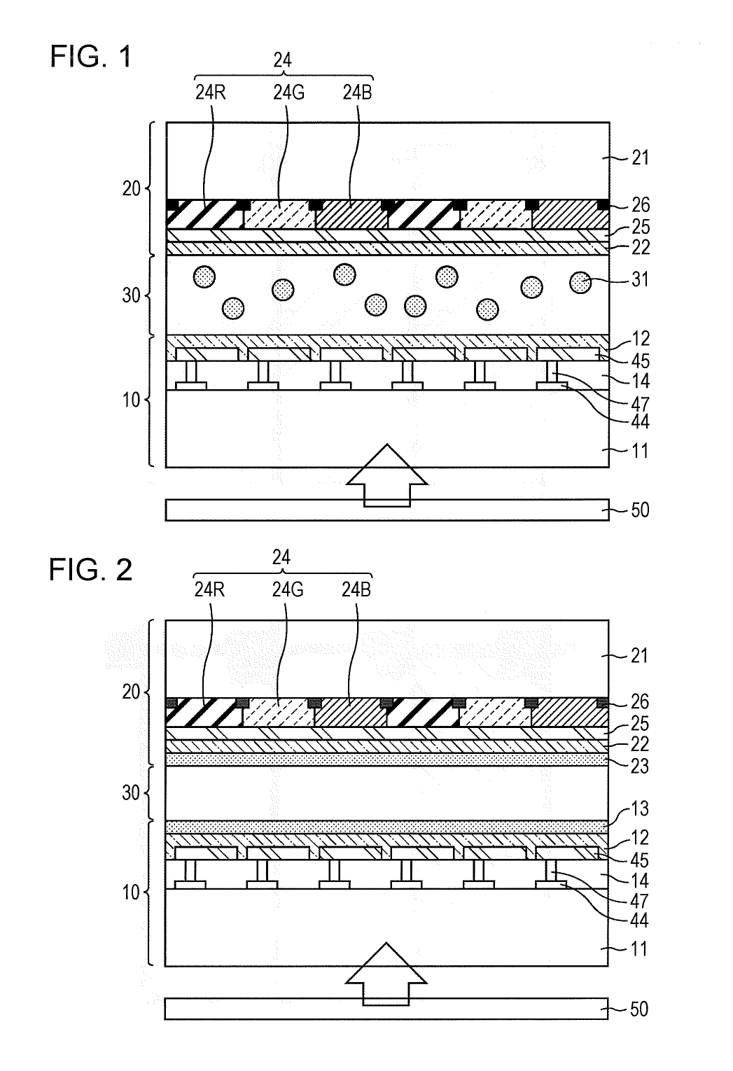

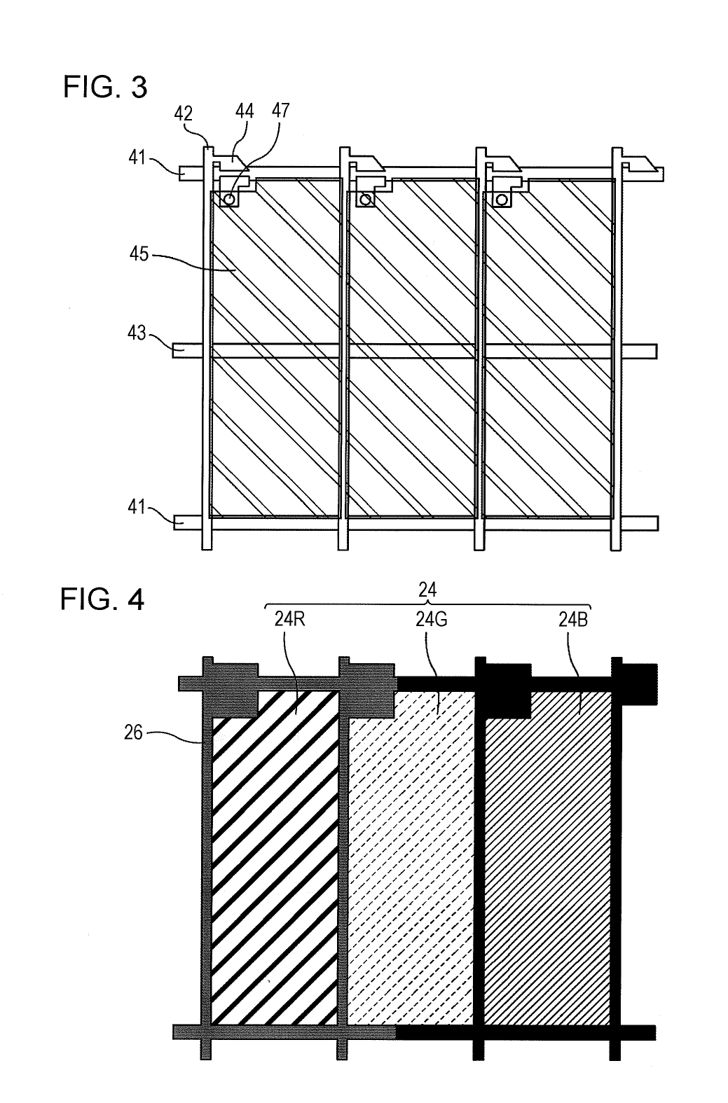

FIGS. 1 and 2 are schematic sectional views of a liquid crystal display device according to a first embodiment. FIG. 1 shows the liquid crystal display device before a PSA polymerization step. FIG. 2 shows the liquid crystal display device after the PSA polymerization step. As shown in FIGS. 1 and 2, the liquid crystal display device according to the first embodiment includes a liquid crystal display panel including an array substrate 10, a counter substrate 20, and a liquid crystal layer 30 interposed between a pair of the array substrate 10 and the counter substrate 20. The liquid crystal display device further includes a backlight 50 placed in rear of the liquid crystal display panel. The liquid crystal display device according to the first embodiment uses light emitted from the backlight 50 to perform display. That is, the liquid crystal display device according to the first embodiment is a transmission type of liquid crystal display device.

The array substrate 10 includes an insulating transparent plate 11 made of glass or the like; conductive members, such as lines, pixel electrodes 45, TFTs (thin-film transistors) 44, and contact portions 47 connecting the TFTs 44 to the pixel electrodes 45, arranged on the transparent plate 11; a plurality of insulating layers 14; and an alignment layer 12. A material for the pixel electrodes 45 is ITO (indium tin oxide). The same material is used in the pixel electrodes 45 and conductive members of the contact portions, whereby structure is streamlined. The alignment layer 12 is made of, for example, a polymeric compound (polyimide) having a main chain with an imide structure. The pretilt angle of liquid crystal molecules can be vertically or horizontally aligned (initially tilted) in such a manner that a surface of the alignment layer 12 is subjected to alignment treatment such as rubbing or photo-alignment treatment. If the alignment layer 12 is not subjected to alignment treatment, a vertical alignment layer or horizontal alignment layer controlling the orientation of liquid crystal molecules adjacent thereto. Such a vertical alignment layer or horizontal alignment layer may be further subjected to alignment treatment. The insulating layers 14 are placed between the TFTs 44 and the pixel electrodes 45. The alignment layer 12 is placed over the pixel electrodes 45 and exposed portions of the insulating layers 14 that are free from the pixel electrodes 45.

The counter substrate 20 includes an insulating transparent plate 21 made of glass or the like, a color filter 24, a black matrix 26, a common electrode 25, and an alignment layer 22. The alignment layer 22 placed on the counter substrate 20 side may be one having substantially the same features as those of the alignment layer 12 placed on the array substrate 10 side.

As shown in FIGS. 1 and 2, the color filter has three colors: red 24R, green 24G, and blue 24B. The type, number, or arrangement of colors is not particularly limited as long as these three colors are used. For example, four colors including yellow may be used. An example of a method of manufacturing the color filter is a photolithographic process in which a pigment-based color resist is applied to glass, followed by exposure and development. In particular, the black matrix is formed on the transparent plate for the purpose of preventing light from the backlight from leaking and preventing color mixing from occurring in the color filter. A color resist is applied to the transparent plate and the black matrix. The color resist is UV-cured by pattern exposure using a photomask and thereby is insolubilized. After unnecessary portions are removed from the color resist using a developer, the color resist is cured by baking. A series of the above steps are repeated depending on the number of colors used in the color filter. An ITO film used to form the common electrode is then formed over the color filter and the black matrix by a sputtering process.

The liquid crystal layer 30 is filled with a liquid crystal material. The type of the liquid crystal material is not particularly limited, may be one having positive dielectric constant anisotropy or one having negative dielectric constant anisotropy, and can be appropriately selected depending on the display mode of a liquid crystal. For example, in a twisted nematic (TN) mode in which molecules are aligned and twisted in a thickness direction of a liquid crystal layer, a liquid crystal material having positive dielectric constant anisotropy is used. In an in-plane switching (IPS) or fringe-field switching (FFS) mode in which liquid crystal molecules are aligned in parallel to a surface of a substrate and a transverse electric field is applied to a liquid crystal layer, a liquid crystal material having positive or negative dielectric constant anisotropy is used. In a vertical alignment (VA) mode in which molecules are aligned vertically to a surface of a substrate, a liquid crystal material having negative dielectric constant anisotropy is used.

As shown in FIG. 1, before the PSA polymerization step, one or more types of monomers 31 are present in the liquid crystal layer 30. The PSA polymerization step initiates the polymerization of the monomers 31, whereby PSA layers 13 and 23 are formed on the alignment layers 12 and 22 as shown in FIG. 2.

In particular, the PSA layers 13 and 23 can be formed in such a manner that a liquid crystal layer-forming composition containing one or more types of monomers 31 and the liquid crystal material is injected between the array substrate 10 and the counter substrate 20, the liquid crystal layer 30 is thereby formed, and the monomers 31 are photo-polymerized by irradiating the liquid crystal layer 30 with a certain amount of light. As shown in FIG. 2, the PSA layers 13 and 23 are each formed over a corresponding one of the alignment layers 12 and 22. PSA layers may be formed thereon in a dotted pattern. The PSA layers 13 and 23 may be varied in thickness.

The monomers 31, which are used in the first embodiment, absorb light alone to generate radicals and initiates chain polymerization; hence, no polymerization initiator needs to be added to the monomers 31. However, in order to increase the polymerization rate, a polymerization initiator making effective use of light with a wavelength of 365 nm or more may be added thereto. Such a polymerization initiator is 2,2-dimethoxy-1,2-diphenylethane-1-on or the like.

In the first embodiment, for example, when the PSA polymerization step is performed, the liquid crystal layer 30 is irradiated with light in such a state that a voltage equal to or more than the threshold voltage is applied to the liquid crystal layer 30, whereby a polymer is formed so as to have a shape following aligned liquid crystal molecules with a voltage equal to or more than the threshold voltage applied thereto. Therefore, even when being free from voltage later, the formed PSA layers 13 and 23 have a structure functioning as an alignment layer controlling the initial pretilt angle of the liquid crystal molecules.

In the first embodiment, the liquid crystal layer 30 need not be irradiated with light in such a state that a voltage equal to or more than the threshold voltage is applied to the liquid crystal layer 30. For example, when the alignment layers 12 and 22 themselves have the ability to impart pretilt alignment to the liquid crystal molecules, the PSA layers 13 and 23, which are placed on the alignment layers 12 and 22, function as films enhancing the alignment stability of the alignment layers. The increase in anchoring force of the alignment layers 12 and 22 controls the liquid crystal molecules to be uniformly aligned, reduces the change in alignment with time, and prevents image sticking from occurring. In the first embodiment, after the alignment layers 12 and 22 are subjected to alignment treatment, the PSA layers 13 and 23 may be formed in such a manner that the liquid crystal layer 30 is irradiated with light in such a state that a voltage equal to or more than the threshold voltage is applied to the liquid crystal layer 30. This allows the alignment layers 12 and 22 and PSA layers 13 and 23, which have high alignment stability, to be combined.

The first embodiment may use a mode (PVA (patterned vertical alignment) mode) in which the alignment of the liquid crystal molecules is controlled by slits provided in the pixel electrodes 45, which are included in the array substrate 10, or the common electrode 25, which are included in the counter substrate 20. In the case of forming narrow linear slits in the pixel electrodes 45 and/or the common electrode 25, the liquid crystal molecules have such an orientation that the liquid crystal molecules are uniformly aligned with the linear slits when a voltage is applied. Therefore, the PSA layers can be formed so as to impart a pretilt angle to the liquid crystal molecules in such a manner that the monomers are polymerized in such a state that a voltage equal to or more than the threshold voltage is applied to the liquid crystal layer 30.

A monomer used in the first embodiment is a condensed aromatic compound represented by the following formula:

P¹-A¹-(Z¹-A²)ₙ-P² (I)

where P¹ and P² are identical to or different from each other and represent an acrylate group or a methacrylate group; Z′ represents one or more groups which are identical to or different from each other and which are COO, OCO, or O or indicates that A¹ and A² or A² and A² are directly bonded to each other; a hydrogen atom may be substituted by a hydrogen atom, a methyl group, an ethyl group, or a propyl group; A¹ and A² represent groups which are identical to or different from each other and each of which is represented by a corresponding one of Chemical Formulae (1-1) to (1-4) below.

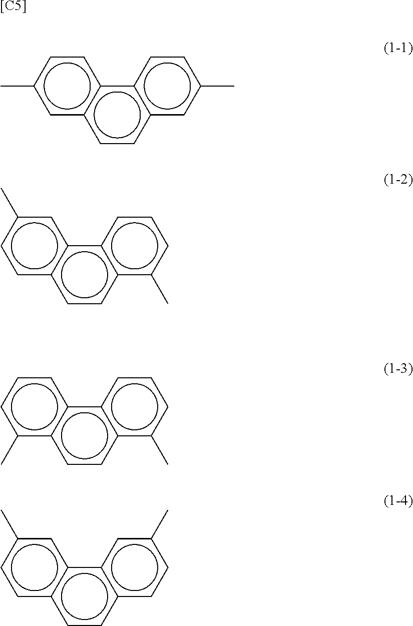

(A hydrogen atom may be substituted by a fluorine atom, a chlorine atom, an OCF₃ group, a CF₃ group, a CH₃ group, a CH₂F group, or a CHF₂ group.)

The monomer, which contains the groups represented by Chemical Formulae (1-1) to (1-4), is a bifunctional monomer and can form a more stable PSA layer as compared to monofunctional groups when being used in combination with the liquid crystal material. Phenanthrene-type condensed aromatic compounds containing three or more benzene rings represented by Chemical Formulae (1-1) to (1-4) have an absorption wavelength of up to about 370 nm. In general, substrates, having an alignment layer thereon, for use in liquid crystal display devices tend to mainly absorb light with a wavelength of less than 330 nm because of the influence of the backbone and side chains of a polymer contained in the alignment layer. Therefore, the use of a monomer which has an absorption wavelength of up to about 370 nm and which contains the groups represented by Chemical Formulae (1-1) to (1-4) enables the increase of light use efficiency and allows a sufficient PSA layer to be prepared even by short-term ultraviolet irradiation.

Other components of the liquid crystal display device according to the first embodiment are described below in detail. FIGS. 3 and 4 are schematic plan views of substrates included in the liquid crystal display device according to the first embodiment. FIG. 3 shows the array substrate. FIG. 4 shows the counter substrate.

As shown in FIG. 3, in the liquid crystal display device according to the first embodiment, the pixel electrodes 45, which are included in the array substrate, have substantially a rectangular shape and are arranged in a matrix pattern or a delta pattern. The term “substantially a rectangular shape” means that a rectangular shape may include a protruding portion and a notched portion as shown in FIG. 3.

The array substrate includes a plurality of gate signal lines 41 extending in parallel to each other, a plurality of source signal lines 42 extending in parallel to each other, and a plurality of auxiliary capacitance (Cs) lines 43 extending in parallel to each other with the insulating layers therebetween. The gate signal lines 41 and the auxiliary capacitance (Cs) lines 43 extend in parallel to each other and intersect with the source signal lines 42. The gate signal lines 41 and the source signal lines 42 are connected to electrodes included in the thin-film transistors (TFTs) 44. The TFTs 44 are three-terminal field-effect transistors and each include a semiconductor layer and three electrodes: a gate electrode, a source electrode, and a drain electrode. The TFTs 44 function as switching elements controlling the operation of pixels. In the first embodiment, multiplex driving may be performed in such a manner that each pixel electrode 45 is divided into sub-pixel electrodes, each of TFTs is connected to a corresponding one of the sub-pixel electrodes, and two of the sub-pixel electrodes are controlled through each of gate signal lines.

As shown in FIG. 4, in the liquid crystal display device according to the first embodiment, the counter substrate 20 includes the BM (black matrix) 26, which is lightproof, and also include red color sub-filters 24R, blue color sub-filters 24B, and green color sub-filters 24G transmitting light with a specific wavelength only. The BM 26 extends between the color filters 24 to form a grid pattern. Each of the color filters 24 is placed so as to overlap a corresponding one of the pixel electrodes of the array substrate.

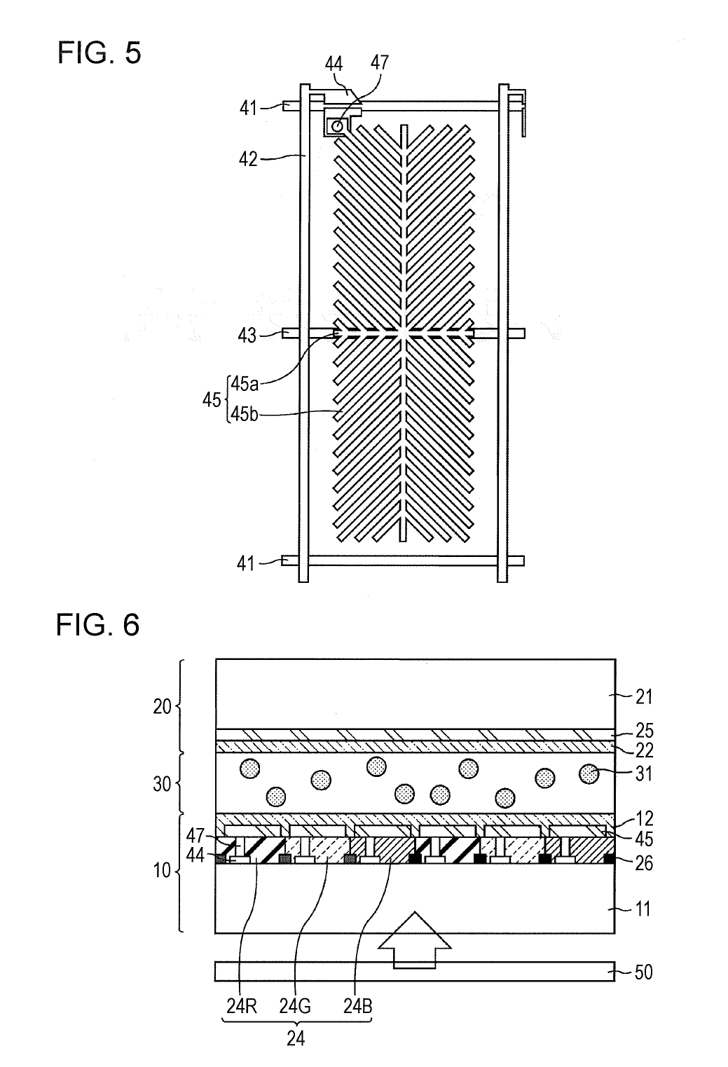

In the first embodiment, the pixel electrodes may have a shape as shown in FIG. 5. FIG. 5 is a schematic plan view of a modification of the pixel electrodes of the liquid crystal display device according to the first embodiment. As shown in FIG. 5, the pixel electrodes 45 are rectangular, each have a plurality of narrow slits extending inward from the periphery thereof, and each include a cross-shaped trunk 45a and a plurality of branches 45b obliquely extending outward from both sides of the trunk 45a. From the viewpoint of enhancing viewing-angle properties, the trunk 45a preferably extend in different directions depending on regions. In particular, supposing that the trunk 45a, which is cross-shaped, extends in a 0-degree direction, a 90-degree direction, a 180-degree direction, and a 270-degree direction, the branches 45b extend in four directions: a 45-degree direction, a 135-degree direction, a 225-degree direction, and a 315-degree direction. When the pixel electrodes have such a shape, alignment treatment such as rubbing or photo-alignment treatment is unnecessary. Since the liquid crystal molecules are tilted to a central portion of each pixel when a voltage is applied thereto, the alignment of the liquid crystal can be stabilized when no voltage is applied thereto in such a manner that the PSA layers are formed by exposure in a voltage-applied state. As a modification of the first embodiment, the following mode is cited: an MVA (multi-domain vertical alignment) mode in which the alignment of liquid crystal molecules is controlled using ribs and electrode slits serving as alignment control structures.

In the first embodiment having pixels shown in FIG. 3 and the like, the alignment layers 12 and 22 may be subjected to alignment treatment such as rubbing or photo-alignment treatment. Photo-alignment treatment can reduce the probability of damaging TFTs or the like. The multi-domain alignment of pixels can be more readily performed as compared to the use of rubbing. As multi-domain alignment, the following mode is cited: a 4-D RTN (4-domain reverse twisted nematic) mode in which alignment treatment directions differ so as to intersect perpendicularly to each other between a pair of substrates and a single pixel is divided into four domains. In the 4-D RTN mode, precise pretilt control is required. The liquid crystal display device according to the first embodiment can achieve a stable pretilt angle due to the influence of the PSA layers formed on the alignment layers and therefore can achieve sufficient alignment stability even if the 4-D RTN mode is used.

In the liquid crystal display device according to the first embodiment, the array substrate 10, the liquid crystal layer 30, and the counter substrate 20 are arranged from the back side to the viewing side of the liquid crystal display device in that order. A polarizer is attached to the back of the array substrate 10. A polarizer is also attached to the back of the counter substrate 20. A retardation film may be attached to each of these polarizers. These polarizers may be circularly polarizing plates.

The liquid crystal display device according to the first embodiment is of a transmission type. The backlight is placed in rear of the array substrate 10 such that light passes the array substrate 10, the liquid crystal layer 30, and the counter substrate 20 in that order. When the liquid crystal display device is of a transflective type, the array substrate 10 includes a reflector for reflecting external light. In a region where reflected light is used as display light, the polarizer attached to the counter substrate 20 needs to be a circularly polarizing plate including a so-called λ/4 retardation film.

The type of the backlight is not particularly limited and may be an edge light type, a direct type, or the like. In a liquid crystal display device including a small-sized screen, display can be performed with low energy consumption using a small number of light sources and an edge light type which is suitable for thinning is widely used.

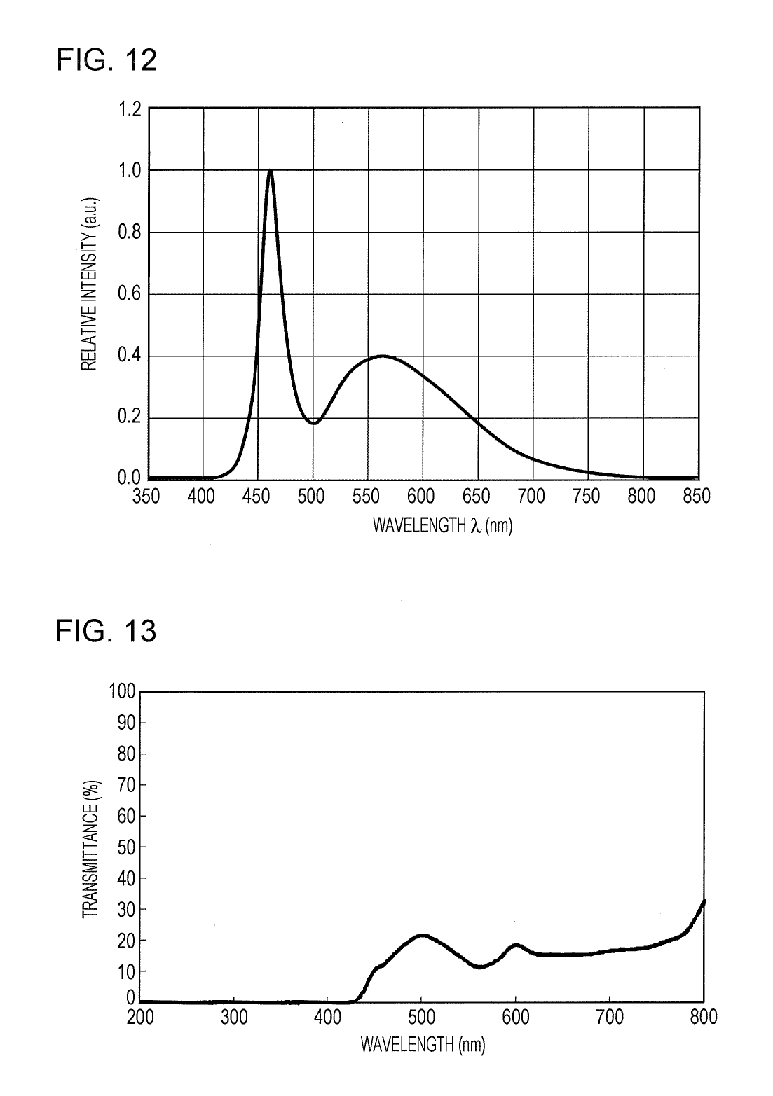

The type of a light source used in the first embodiment is a light-emitting diode (LED). In the first embodiment, the LED is controlled so as not to emit light with a wavelength of substantially less than 400 nm. In the first embodiment, the LED is preferably controlled so as not to emit light with a wavelength of substantially less than 420 nm. For example, a white LED illustrated in a graph shown in FIG. 12 does not emit light with a wavelength of substantially 420 nm or less and therefore significantly contributes to reducing the occurrence of image sticking.

Members of the backlight are the light source, a reflective sheet, a diffusing sheet, a prism sheet, a light guide plate, and the like. When the backlight is of an edge light type, light emitted from the light source enters the light guide plate from a side surface of the light guide plate, is reflected, is diffused, is emitted from a principal surface of the light guide plate in the form of planar light, passes through the prism sheet, and is then emitted in the form of display light. When the backlight is of a direct type, light emitted from the light source directly passes through the reflective sheet, the diffusing sheet, the prism sheet, and the like without entering the light guide plate and is then emitted in the form of display light.

In the liquid crystal display device according to the first embodiment, components of the alignment layers can be analyzed, components of PSA layer-forming monomers (monomers) present in the PSA layers can be analyzed, and the amount of the PSA layer-forming monomers (monomers) contained in the liquid crystal layer, the abundance of the PSA layer-forming monomers (monomers) in the PSA layers, and the like can be checked in such a manner that the alignment layers are taken by disassembling the liquid crystal display device (for example, a liquid crystal TV (television)) and are chemically analyzed by ¹³C-nuclear magnetic resonance (NMR), mass spectrometry (MS), and the like.

### Example 1

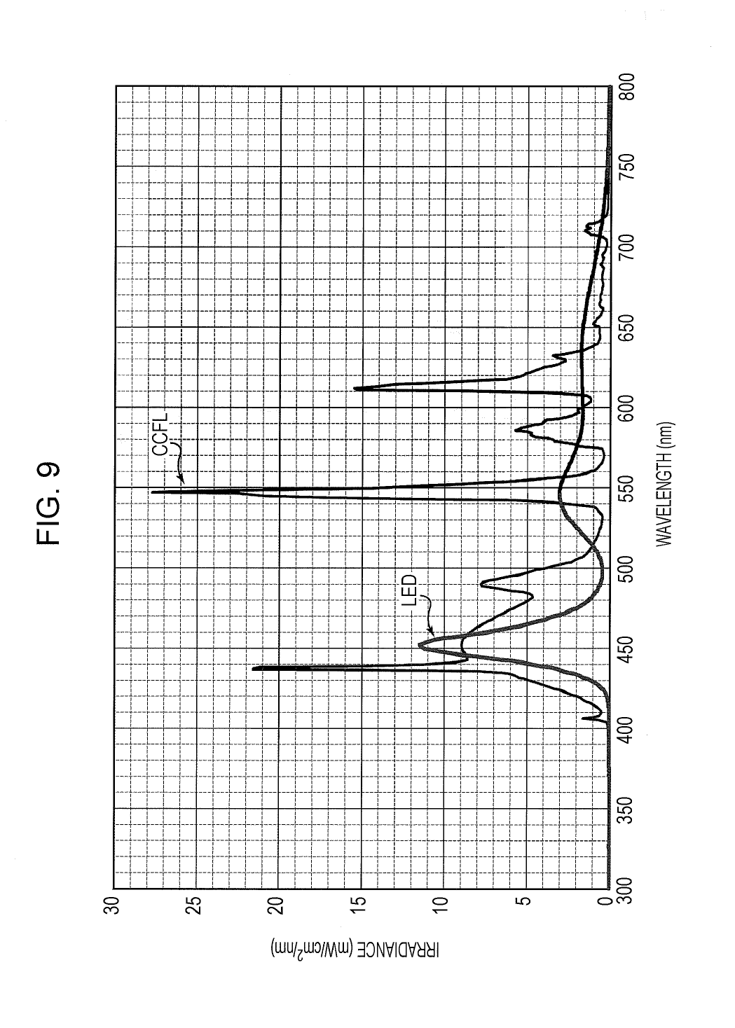

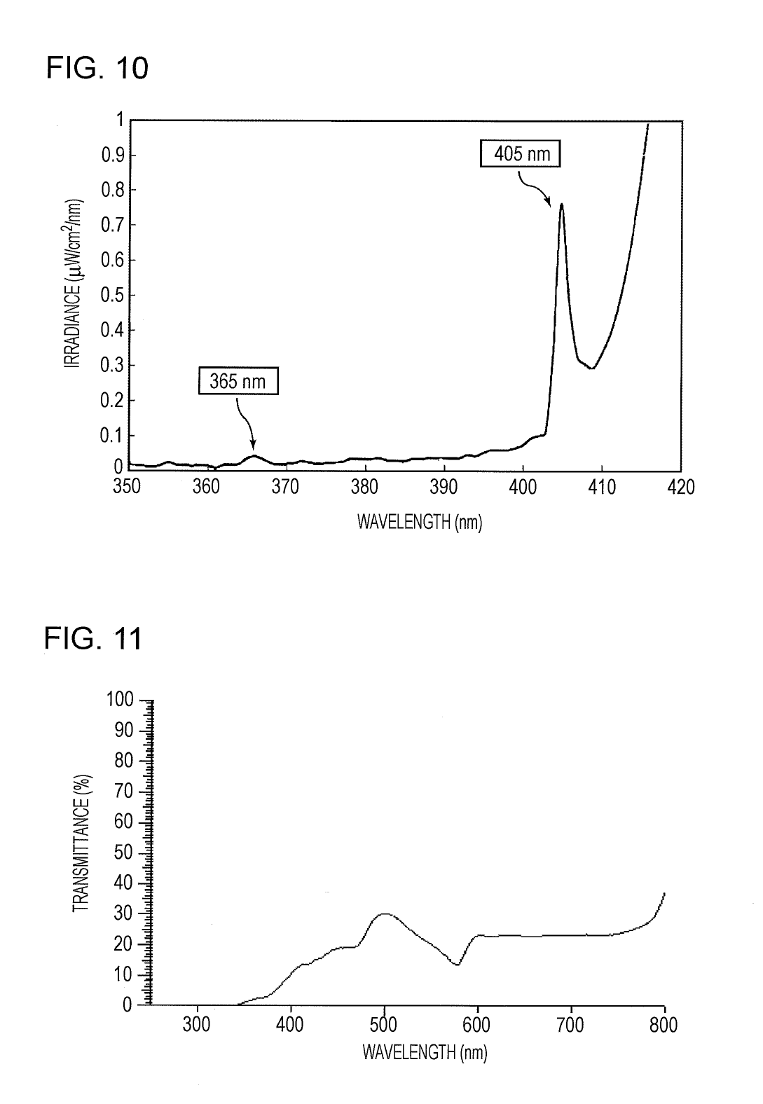

A liquid crystal display panel according to the first embodiment was actually prepared and was checked for image sticking. A light source used in Example 1 was an LED having an emission spectrum shown in FIGS. 9 and 10 and did not emit light with a wavelength of substantially less than 400 nm. On the other hand, in a CCFL having an emission spectrum shown in FIGS. 9 and 10, an extremely small peak (about 0.04 μW/cm²) was observed at about 365 nm.

A pair of substrates, that is, an array substrate and a counter substrate were prepared. After a liquid crystal layer-forming composition containing a liquid crystal material and a monomer for forming PSA layers was dripped, the substrates were bonded to each other. The counter substrate had a color filter prepared therein.

In Example 1, the monomer used to form the PSA layers was a compound represented by Chemical Formula (3) below.

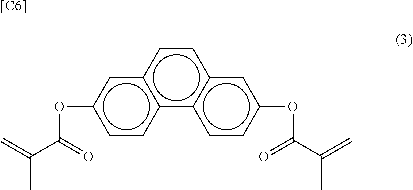

The compound represented by Chemical Formula (3) was a phenanthrene-based bifunctional methacrylate monomer. In Example 1, the liquid crystal layer-forming composition was prepared so as to contain 0.6% by weight of the phenanthrene-based bifunctional monomer.

A polymerization reaction was carried out in such a manner that a liquid crystal layer interposed between the substrates was irradiated with ultraviolet light at 1 J/cm² in such a state that an AC voltage of 10 V was applied to the liquid crystal layer, whereby a liquid crystal cell was completed such that the PSA layers were formed on alignment layers. The time for which the liquid crystal cell was irradiated with ultraviolet light was three minutes. An ultraviolet light source used was a high-pressure mercury lump (manufactured by ORC Manufacturing Co., Ltd.). Thereafter, the liquid crystal cell was irradiated with light from a light source, FHF32-BLB (manufactured by Toshiba Lighting & Technology Corporation), for one hour without applying voltage thereto. Alignment layers subjected to alignment treatment were used in the liquid crystal display panel and therefore a step of applying voltage was omitted.

Subsequently, the completed liquid crystal display panel was placed onto an LED backlight to display an image and the image sticking rate thereof was measured. In Example 1, the image sticking rate was defined as described below and was quantitatively evaluated by a method below. First, a black-and-white checkered pattern was displayed on a display region for 600 hours. Thereafter, a predetermined halftone (gray) pattern was displayed on the whole of the display region. The difference β-γ between the luminance β of a region that displayed white and the luminance γ of a region that displayed black was divided by the luminance γ of the region that displayed black, whereby the image sticking rate was calculated. That is, the image sticking rate is given by the following equation:

Image sticking rate α=((β−γ)/γ)×100(%).

As a result, the liquid crystal display panel prepared in Example 1 had an image sticking rate of 4%.

### Comparative Example 1

In order to check the difference between an LED and a CCFl, a liquid crystal display panel similar to that prepared in Example 1 was actually prepared. The completed liquid crystal display panel was placed onto a CCFL backlight having an emission spectrum shown in FIG. 9 to display an image and the image sticking rate thereof was measured. The definition and evaluation method of the image sticking rate are the same as those described in Example 1.

As a result, the liquid crystal display panel prepared in Comparative Example 1 had an image sticking rate of 6%. It was demonstrated that the use of the CCFL caused a slight amount of a monomer remaining in a liquid crystal layer to be polymerized and therefore caused image sticking.

### Second Embodiment

A liquid crystal display device according to a second embodiment is substantially the same as that according to the first embodiment except that a color filter-on-array (COA) in which a color filter is not formed in a counter substrate but an array substrate is used and a light source is not limited to an LED.

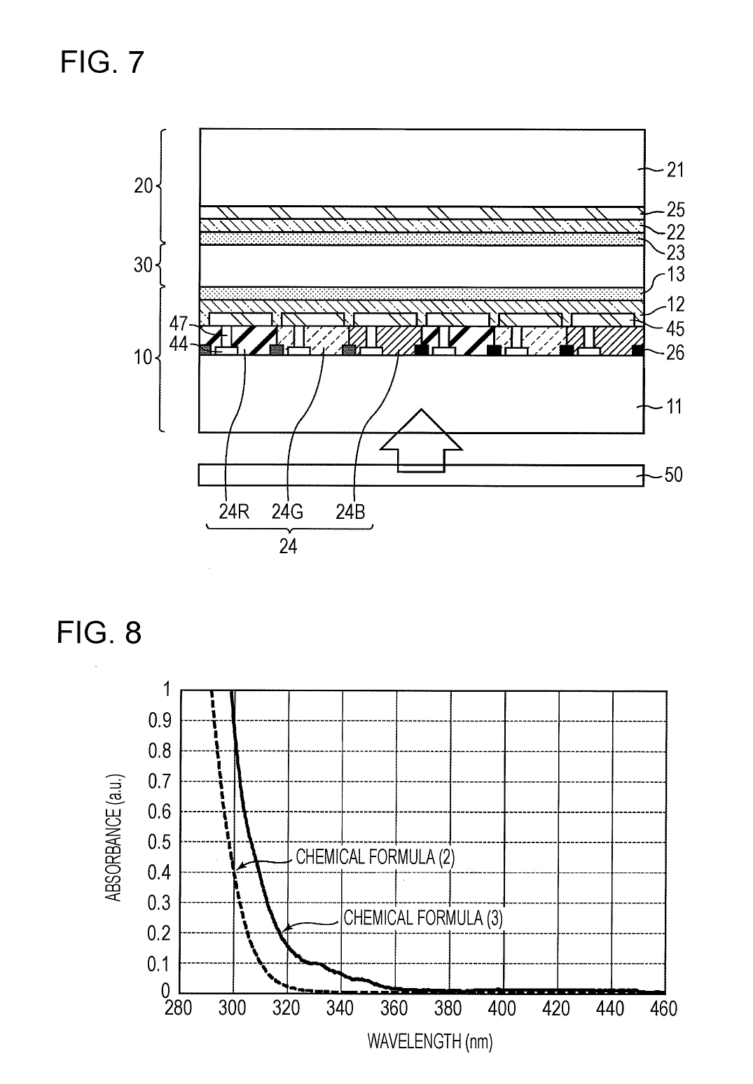

FIGS. 6 and 7 are schematic sectional views of the liquid crystal display device according to the second embodiment. FIG. 6 shows the liquid crystal display device before a PSA polymerization step. FIG. 7 shows the liquid crystal display device after the PSA polymerization step. In the second embodiment, as shown in FIGS. 6 and 7, a color filter 24 and a black matrix 26 are placed in an array substrate 10. In particular, TFTs 44 and a bus line (not shown) are arranged on an insulating transparent plate 11 made of glass or the like and the black matrix 26 and the color filter 24 are placed thereabove with an insulating layer (not shown) therebetween. Another insulating layer is placed on the color filter 24 in some cases. The black matrix is placed only on the counter substrate side in some cases. Pixel electrodes 45 are arranged at positions overlapping the color filter 24. The pixel electrodes 45 are connected to the TFTs 44 through contact portions 47 formed in the color filter 24. When an insulating layer is present over the pixel electrodes 45 and surface portions of the color filter 24 that are exposed from the pixel electrodes 45 or present on the color filter 24, an alignment layer 12 is placed on this insulating layer. FIGS. 6 and 7 show the color filter, which has three colors: red 24R, green 24G, and blue 24B. The color filter used in the second embodiment, the type, number, or arrangement of colors is not particularly limited as long as a filter that does not transmit light with a wavelength of substantially less than 350 nm is selected. In the second embodiment, it is preferred that the color filter does not transmit light with a wavelength of substantially less than 420 nm. For example, the use of a color filter absorbing light with a wavelength of less than 420 nm as shown in FIG. 13 substantially eliminates light with ultraviolet wavelengths and therefore significantly contributes to reducing the occurrence of image sticking.

The color filter-on-array solves a problem with misalignment due to the fact that pixel electrodes and a color filter are formed in different substrates.

The type of a backlight 50 used in the second embodiment is a light-emitting diode (LED) or a cold cathode fluorescent lamp (CCFL).

### Example 2

A liquid crystal display panel according to the second embodiment was actually prepared and was checked for image sticking. A light source used in Example 2 was a CCFL having an emission spectrum shown in FIGS. 9 and 10 and slightly contained ultraviolet light.

A pair of substrates, that is, an array substrate and a counter substrate were prepared. After a liquid crystal layer-forming composition containing a liquid crystal material and a monomer, represented by Chemical Formula (3), for forming PSA layers was dripped, the substrates were bonded to each other. The array substrate had a color filter prepared therein. The color filter used in Example 2 has an emission spectrum shown in FIG. 11 and does not transmit light with a wavelength of substantially less than 350 nm.

A polymerization reaction was carried out in such a manner that a liquid crystal layer interposed between the substrates was irradiated with ultraviolet light at 3 J/cm² in such a state that an AC voltage of 10 V was applied to the liquid crystal layer, whereby a liquid crystal cell was completed such that the PSA layers were formed on alignment layers. The time for which the liquid crystal cell was irradiated with ultraviolet light was three minutes. An ultraviolet light source used was a high-pressure mercury lump (manufactured by ORC Manufacturing Co., Ltd.). Thereafter, the liquid crystal cell was irradiated with light from a light source, FHF32-BLB (manufactured by Toshiba Lighting & Technology Corporation), for one hour without applying voltage thereto. Alignment layers subjected to alignment treatment were used in the liquid crystal display panel and therefore a step of applying voltage was omitted.

Subsequently, the completed liquid crystal display panel was placed onto a CCFL backlight to display an image and the image sticking rate thereof was measured. The definition and evaluation method of the image sticking rate are the same as those described in Example 1.

As a result, the liquid crystal display panel prepared in Example 2 had an image sticking rate of 5%.

### Example 3

A liquid crystal display panel according to the second embodiment was actually prepared and was checked for image sticking. A light source used in Example 3 was an LED having an emission spectrum shown in FIGS. 9 and 10 and did not have light with a wavelength of substantially less than 400 nm.

A pair of substrates, that is, an array substrate and a counter substrate were prepared. After a liquid crystal layer-forming composition containing a liquid crystal material and a monomer, represented by Chemical Formula (3), for forming PSA layers was dripped, the substrates were bonded to each other. The array substrate had a color filter prepared therein. The color filter used in Example 3 has an emission spectrum shown in FIG. 11 and does not transmit light with a wavelength of substantially less than 350 nm.

A polymerization reaction was carried out in such a manner that a liquid crystal layer interposed between the substrates was irradiated with ultraviolet light at 3 J/cm² in such a state that an AC voltage of 10 V was applied to the liquid crystal layer, whereby a liquid crystal cell was completed such that the PSA layers were formed on alignment layers. The time for which the liquid crystal cell was irradiated with ultraviolet light was three minutes. An ultraviolet light source used was a high-pressure mercury lump (manufactured by ORC Manufacturing Co., Ltd.). Thereafter, the liquid crystal cell was irradiated with light from a light source, FHF32-BLB (manufactured by Toshiba Lighting & Technology Corporation), for one hour without applying voltage thereto. Alignment layers subjected to alignment treatment were used in the liquid crystal display panel and therefore a step of applying voltage was omitted.

Subsequently, the completed liquid crystal display panel was placed onto an LED backlight to display an image and the image sticking rate thereof was measured. The definition and evaluation method of the image sticking rate are the same as those described in Example 1.

As a result, the liquid crystal display panel prepared in Example 3 had an image sticking rate of 3%.

This application is based on Japanese Patent Application No. 2010-201210 filed on Sep. 8, 2010 and claims priority under the Paris Convention or laws and regulations in destination countries. The entire contents of this application are incorporated herein by reference.

### REFERENCE SIGNS LIST

10 Array substrate
11, 21 Transparent plate
12, 22 Alignment layer
13, 23 PSA layer (polymer layer)
14 Insulating layers
20 Counter substrate
24 Color filter
24R Red (R) color sub-filters
24G Green (G) color sub-filters
24B Blue (B) color sub-filters
25 Common electrode
26 Black matrix
30 Liquid crystal layer
31 Monomers
41 Gate signal lines
42 Source signal lines
43 Auxiliary capacitance (Cs) lines
44 TFTs
45 Pixel electrodes
47 Contact portions
50 Backlight

1. A liquid crystal display device comprising a liquid crystal display panel including a pair of substrates and a liquid crystal layer interposed between the substrates and a backlight placed in rear of the liquid crystal display panel, wherein at least one of the substrates includes an alignment layer controlling the alignment of liquid crystal molecules adjacent thereto and a polymer layer which is placed on the alignment layer and which controls the alignment of the liquid crystal molecules adjacent thereto, the polymer layer is one formed by polymerizing a monomer added to the liquid crystal layer, the backlight includes a light source including at least one light-emitting diode, the light-emitting diode emits light with a wavelength of substantially 400 nm or more only, and the monomer is a compound represented by the following formula:
P¹-A¹-(Z¹-A²)ₙ-P² (I)
where P¹ and P² are identical to or different from each other and represent an acrylate group or a methacrylate group; Z′ represents one or more groups which are identical to or different from each other and which are COO, OCO, or O or indicates that A¹ and A² or A² and A² are directly bonded to each other; a hydrogen atom may be substituted by a hydrogen atom, a methyl group, an ethyl group, or a propyl group; A¹ and A² represent groups which are identical to or different from each other and each of which is represented by a corresponding one of the following formulae: 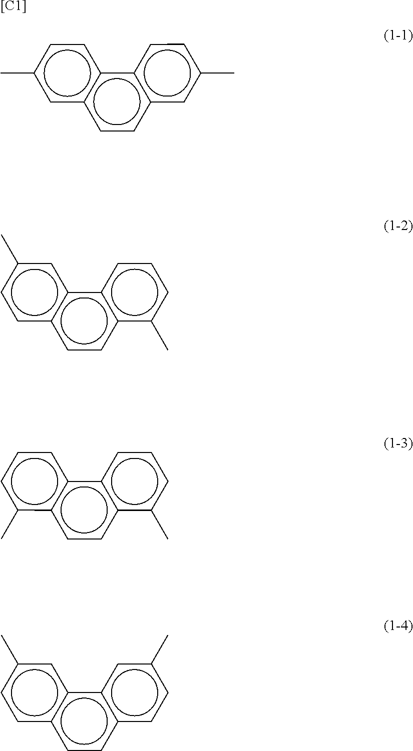
where a hydrogen atom may be substituted by a fluorine atom, a chlorine atom, an OCF₃ group, a CF₃ group, a CH₃ group, a CH₂F group, or a CHF₂ group.

2. A liquid crystal display device comprising a liquid crystal display panel including a pair of substrates and a liquid crystal layer interposed between the substrates and a backlight placed in rear of the liquid crystal display panel, wherein at least one of the substrates includes an alignment layer controlling the alignment of liquid crystal molecules adjacent thereto and a polymer layer which is placed on the alignment layer and which controls the alignment of the liquid crystal molecules adjacent thereto, the polymer layer is one formed by polymerizing a monomer added to the liquid crystal layer, one of the substrates that is closer to the backlight includes a multi-color filter, the multi-color filter transmits light with a wavelength of substantially 350 nm or more only, and the monomer is a compound represented by the following formula:
P¹-A¹-(Z¹-A²)ₙ-P² (I)
where P¹ and P² are identical to or different from each other and represent an acrylate group or a methacrylate group; Z¹ represents one or more groups which are identical to or different from each other and which are COO, OCO, or O or indicates that A¹ and A² or A² and A² are directly bonded to each other; a hydrogen atom may be substituted by a hydrogen atom, a methyl group, an ethyl group, or a propyl group; A¹ and A² represent groups which are identical to or different from each other and each of which is represented by a corresponding one of the following formulae: 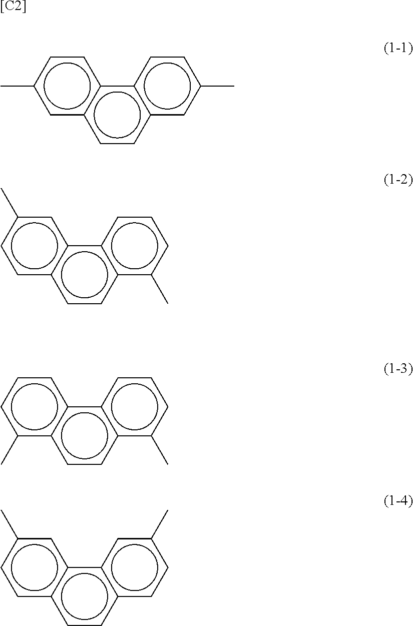
where a hydrogen atom may be substituted by a fluorine atom, a chlorine atom, an OCF₃ group, a CF₃ group, a CH₃ group, a CH₂F group, or a CHF₂ group.

3. The liquid crystal display device according to claim 1, wherein one of the substrates that is closer to the backlight includes a multi-color filter and the multi-color filter transmits light with a wavelength of substantially 350 nm or more only.

4. The liquid crystal display device according to claim 2, wherein the backlight includes a light source including at least one light-emitting diode and the light-emitting diode emits light with a wavelength of substantially 400 nm or more only.

5. The liquid crystal display device according to claim 1, wherein the light-emitting diode emits light with a wavelength of substantially 420 nm or more only.

6. The liquid crystal display device according to claim 2, wherein the multi-color filter transmits light with a wavelength of substantially 420 nm or more only.

7. The liquid crystal display device according to claim 4, wherein the light-emitting diode emits light with a wavelength of substantially 420 nm or more only.

8. The liquid crystal display device according to claim 3, wherein the multi-color filter transmits light with a wavelength of substantially 420 nm or more only.
